(19) United States
(12) Patent Application Publication
(10) Pub. No.: US 2010/0235610 A1
(43) Pub. Date: Sep. 16, 2010

(54) PROCESSING SYSTEM, PROCESSING APPARATUS AND COMPUTER READABLE MEDIUM

(75) Inventors: Hajime Ueno, Ashigarakami-gun (JP); Toshiroh Shimada, Ashigarakami-gun (JP); Yoko Kurihara, Ashigarakami-gun (JP); Naoki Hayashi, Ashigarakami-gun (JP); Tomoyuki Shoya, Ashigarakami-gun (JP); Hitsohi Ikeda, Ashigarakami-gun (JP); Yasunori Saito, Tokyo (JP); Masamichi Takahashi, Ashigarakami-gun (JP)

Correspondence Address: SUGHRUE-265550, 2100 PENNSYLVANIA AVE. NW, WASHINGTON, DC, 20037-3213, US

(73) Assignee: FUJI XEROX CO., LTD., Tokyo (JP)

(21) Appl. No.: 12/502,751

(22) Filed: Jul. 14, 2009

(30) Foreign Application Priority Data
Mar. 10, 2009 (JP) 2009-056592

(51) Int. Cl. G06F 15/76; G06F 9/06

(52) U.S. Cl. 712/30; 712/E09.003

(57) ABSTRACT

A processing apparatus includes: an operation detection unit that detects an operation; a request unit that requests other processing apparatuses to transmit functions when the operation is detected by the operation detection unit; a receiving unit that receives replies in response to the requests of the request unit from the at least one of the other processing apparatuses; a selection unit that selects at least one of the other processing apparatuses from which the receiving unit has received the replies; and a communication unit that performs communication with the at least one of the other processing apparatuses selected by the selection unit.

### CROSS-REFERENCE TO RELATED APPLICATIONS

This application is based on and claims priority under 35 USC 119 from Japanese Patent Application No. 2009-056592 filed Mar. 10, 2009.

### BACKGROUND

1. Technical Field

The present invention relates to a processing system, a processing apparatus, and a computer readable medium.

2. Related Art

In order to perform processing by cooperation of a plurality of processing apparatuses not by one processing apparatus, unifying the communication between the processing apparatuses, registering the request function information in other processing apparatuses beforehand, and the like are performed.

### SUMMARY

According to an aspect of the invention, a processing system includes a first processing apparatus; and second processing apparatuses. The first processing apparatus includes: an operation detection unit that detects an operation; a request unit that requests the second processing apparatuses to transmit functions when the operation is detected by the operation detection unit; a receiving unit that receives replies in response to the requests of the request unit from at least one of the second processing apparatuses; a selection unit that selects at least one of the second processing apparatuses from which the receiving unit has received the replies; and a communication unit that performs communication with the at least one of the second processing apparatuses selected by the selection unit. Each of the second processing apparatuses includes: a receiving unit that receives the request of the function transmitted from the first processing apparatus; a transmission unit that transmits its own function to the first processing apparatus in response to the request received by the receiving unit; and a communication unit that performs communication with the first processing apparatus.

### BRIEF DESCRIPTION OF THE DRAWINGS

Exemplary embodiment(s) of the present invention will be described in detail based on the following figures, wherein:

FIG. 1 is a view illustrating the conceptual module configuration in a configuration example of the present exemplary embodiment;

FIG. 2 is a view illustrating the conceptual module configuration mainly in a configuration example of the cooperation control device of the present exemplary embodiment for an input function;

FIG. 3 is an explanatory view illustrating an example of the data structure of a connection information table;

FIG. 4 is an explanatory view illustrating an example of the data structure of a connection candidate table;

FIG. 5 is an explanatory view illustrating an example of the data structure of a self-information table;

FIG. 6 is a flow chart illustrating an example of processing in the present exemplary embodiment for an input function;

FIG. 7 is a view illustrating the conceptual module configuration mainly in a configuration example of a cooperation control device of the present exemplary embodiment for an output function;

FIG. 8 is an explanatory view illustrating an example of the data structure of the connection information table;

FIG. 9 is an explanatory view illustrating an example of the data structure of the self-information table;

FIG. 10 is a flow chart illustrating an example of processing in the present exemplary embodiment for an output function;

FIG. 11 is a view illustrating the conceptual module configuration mainly in a configuration example of a cooperation control device of the present exemplary embodiment for a processing function;

FIG. 12 is a timing chart illustrating examples of cooperation processing using PC-A and PC-B;

FIG. 13 is a timing chart illustrating examples of cooperation processing using PC-A and PC-B;

FIG. 14 is an explanatory view illustrating an example of display in the case of selection processing of the present exemplary embodiment; and

FIG. 15 is a block diagram illustrating an example of the hardware configuration of the computer for realizing the present exemplary embodiment.

### DETAILED DESCRIPTION

Hereinafter, an exemplary embodiment which is suitable for realizing the invention will be described with references to the accompanying drawings.

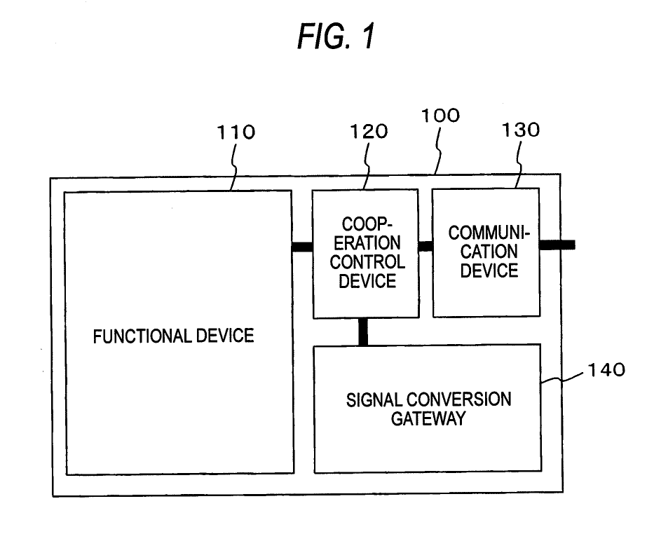

FIG. 1 is a view illustrating the conceptual module configuration in a configuration example of the present exemplary embodiment.

In addition, a module generally refers to logically separable components, such as software (computer program) and hardware. Therefore, a module in the present exemplary embodiment indicates not only a module in a computer program but also a module in the hardware configuration. Thus, in the present exemplary embodiment, a method is also described in addition to a computer program and a system. In addition, ‘store’, ‘cause to be stored’, and words equivalent thereto are used for the convenience of explanation, and these words mean being stored in the storage device or making a control to be stored in the storage device in the case when the exemplary embodiment is a computer program. In addition, a module corresponds to a function in almost one-to-one manner. However, at the time of mounting, one module may be realized using one program or a plurality of modules may be realized using one program. Alternatively, one module may be realized using a plurality of programs. In addition, a plurality of modules may be executed by one computer, or one module may be executed by a plurality of computers in a distribution or parallel environment. In addition, other modules may be included in one module. In addition, ‘connection’ referred hereinafter is used not only for physical connection (for example, communication) but also for logical connection (for example, transmission and reception of data, instruction, and reference relationship between data).

In addition, a system or an apparatus may be realized by connecting a plurality of computers, hardware, apparatuses, and the like to one another through a communication unit, such as a network (including communication connection of one-to-one correspondence), or may be realized using one computer, hardware, and an apparatus. The ‘apparatus’ and the ‘system’ are used as synonymous terms. ‘Set beforehand’ refers to being set before target processing and is used as meaning including not only being set before processing of the present exemplary embodiment starts but also being set after processing of the present exemplary embodiment started according to situation and state at that time or situation and state until then as long as it is before target processing.

A processing apparatus 100 which is the present exemplary embodiment performs communication with another processing apparatus to realize flexible cooperation processing with the processing apparatus and includes a functional device 110, a cooperation control device 120, a communication device 130, and a signal conversion gateway 140 as shown in FIG. 1. In addition, the processing apparatus 100 does not perform connection of the relation of master and servant, such as server and client, but performs an ad hoc connection according to the environment. That is, the user determines the processing apparatus to be connected after checking what can be done using the processing apparatus in the neighborhood.

The functional device 110 is connected to the cooperation control device 120 and performs processing for realizing the function of the processing apparatus 100 itself. That is, the functional device 110 has the original function that the processing apparatus 100 has and cooperates with another processing apparatus 100 through the cooperation control device 120 to perform the processing. Here, the original function that the processing apparatus 100 has is classified into three kinds of functions of input which is reception of information, processing, and output. The functional device 110 is for realizing any one of the functions.

Examples of the functional device 110 having the input function include a keyboard, a mouse, and a scanner. The functional device 110 having the input function performs processing for inputting data in the information processing system or a part thereof when cooperating with another processing apparatus for storage or processing. The functional device 110 with the input function receives the user's operation and converts it into data. In other words, the functional device 110 with the input function converts the analog operation into digital data.

Then, examples of the functional device 110 having the function of processing include a PC (personal computer) and a processing apparatus portion of a server. The functional device 110 with the processing function systematically executes the operation performed for data received from the functional device 110 with an input function or the functional device 110 with another processing function. For example, the functional device 110 with the processing function performs the arithmetic operation or logic operation for the data, merging or alignment of data, assembling or compiling for a program, text editing, classification, merging, and search. The functional device 110 with the processing function converts the analog data into digital data.

Finally, examples of the functional device 110 having an output function include a display, a projector, a printer, and a speaker. The functional device 110 having an output function presents data to the user. In other words, the functional device 110 with the output function converts digital data into an analog form.

Accordingly, the notebook PC with a keyboard, a display, and a processing apparatus portion which is the main body may be abstracted as the apparatus in which the processing apparatus 100 with the input function, the processing apparatus 100 having the output function, and the processing apparatus 100 with the processing function cooperate with each other. In addition, the projector may be abstracted as the processing apparatus 100 having the output function. For example, by making the four processing apparatuses 100 cooperate with each other, it is possible to process the operation of a keyboard of the notebook PC in the processing apparatus of the notebook PC and to output the processing result to both the display of the notebook PC and the projector.

The cooperation control device 120 is connected with the functional device 110, the communication device 130, and the signal conversion gateway 140. The cooperation control device 120 receives a signal from the communication device 130. If the signal cannot be processed by the functional device 110, the cooperation control device 120 makes the signal conversion gateway 140 convert the signal and makes the functional device 110 perform data processing. If necessary, the cooperation control device 120 transmits the processing result to another processing apparatus 100 through the communication device 130. In addition, the different processing is performed according to the function that the functional device 110 has.

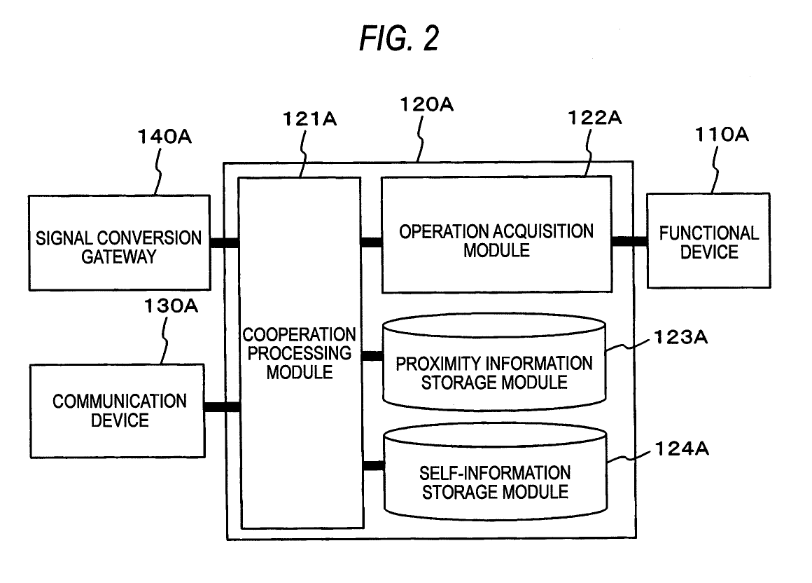

In the case of the functional device 110 having the input function, the cooperation control device 120 performs processing, such as a search request of another processing apparatus 100, storage of information on another processing apparatus 100 which is the connection candidate, and the request of connection with another processing apparatus 100. The processing will be described later with reference to FIGS. 2 to 6.

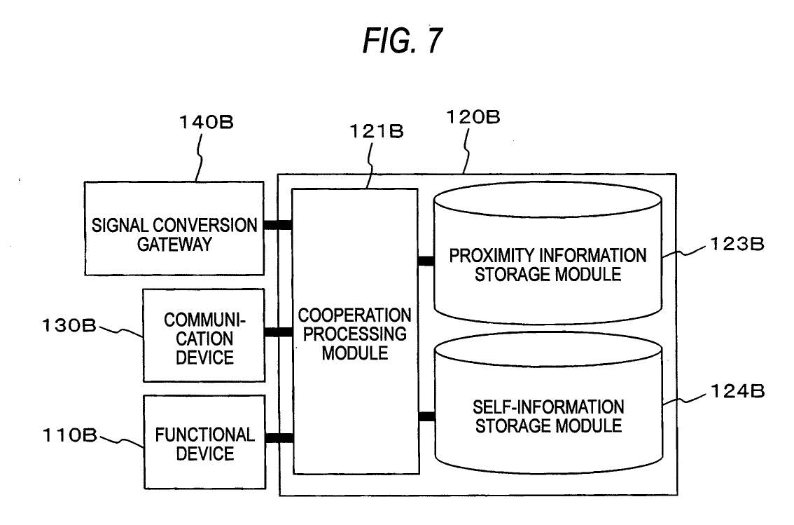

In the case of the functional device 110 having the output function, the cooperation control device 120 performs processing, such as generation of the response to the request from another processing apparatus 100. The processing will be described later with reference to FIGS. 7 to 10.

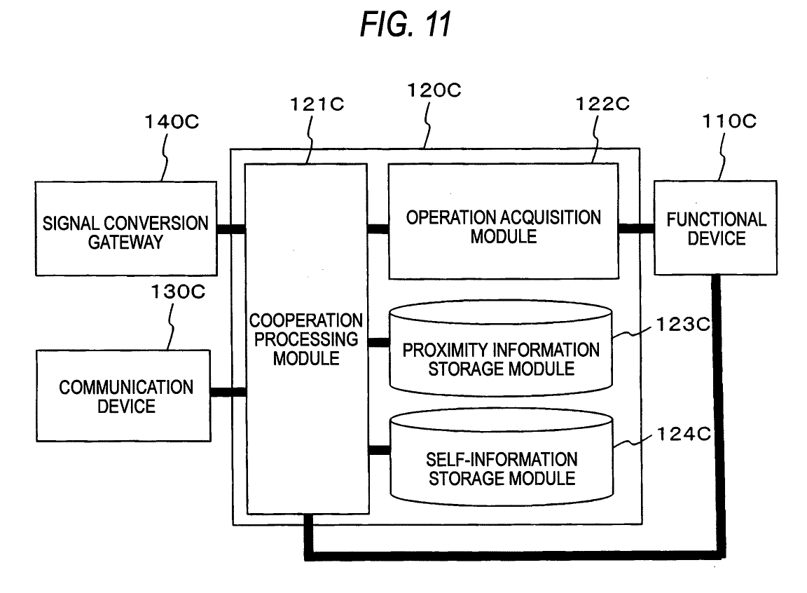

In the case of the functional device 110 having the processing function, the cooperation control device 120 performs processing, such as a search request of another processing apparatus 100, and the request of connection with another processing apparatus 100. The processing will be described later with reference to FIG. 11.

The communication device 130 is connected with the cooperation control device 120, and is the interface for communication with another processing apparatus 100 and it is the physical connection interface. The communication device 130 receives the communication signal from another processing apparatus 100 located outside and transmits the signal to the cooperation control device 120. For example, a port or a connector corresponds to the communication device 130.

The signal conversion gateway 140 is connected with the cooperation control device 120. The signal conversion gateway 140 is the gateway for converting the communication signal, which is received from the cooperation control device 120, into a signal based on a common standard in order to perform communication with another processing apparatus 100 using a different communication standard.

FIG. 2 is a view illustrating the conceptual module configuration mainly in the configuration example of the cooperation control device 120 of the present exemplary embodiment for an input function. A functional device 110A, a cooperation control device 120A, a communication device 130A, and a signal conversion gateway 140A are included in the conceptual module configuration.

The functional device 110A is connected with an operation acquisition module 122A of the cooperation control device 120A and corresponds to the functional device 110 shown in the example of FIG. 1. For example, the functional device 110A receives the user's key operation on the keyboard and transmits it to the operation acquisition module 122A.

The communication device 130A is connected with a cooperation processing module 121A of the cooperation control device 120A and corresponds to the communication device 130 shown in the example of FIG. 1. In order to perform communication with another processing apparatus 100, the communication device 130A transmits the signal from the cooperation processing module 121A to another processing apparatus 100 and receives a signal from another processing apparatus 100 and transmits it to the cooperation processing module 121A.

The signal conversion gateway 140A is connected to the cooperation processing module 121A of the cooperation control device 120A and corresponds to the signal conversion gateway 140 shown in the example of FIG. 1. The signal conversion gateway 140A converts a signal into a signal treated by the cooperation processing module 121A and the like in response to an instruction from the cooperation processing module 121A.

The cooperation control device 120A includes the cooperation processing module 121A, the operation acquisition module 122A, a proximity information storage module 123A, and a self-information storage module 124A and corresponds to the cooperation control device 120 shown in the example of FIG. 1.

The operation acquisition module 122A is connected to the functional device 110A and the cooperation processing module 121A and detects the contents of a user's operation on the functional device 110A. The detected contents are transmitted to the cooperation processing module 121A. The present exemplary embodiment starts when the processing apparatus 100 having an input function, which is communicably connected, starts to be used. Examples of the start include an operation (including motion and the like) of opening the cover of a scanner and the operation of opening a cap of the electronic pen.

The cooperation processing module 121A is connected to the operation acquisition module 122A, the proximity information storage module 123A, the self-information storage module 124A, the communication device 130A, and the signal conversion gateway 140A. When the operation is detected by the operation acquisition module 122A, the cooperation processing module 121A requests the function transmission to another processing apparatus 100. That is, the cooperation processing module 121A searches the function that the processing apparatus 100, which may serve as the cooperator, has. Here, the transmission of the search request is not a transmission to the specific processing apparatus 100 but the transmission to the unspecified processing apparatus 100. For example transmission by broadcasting can be mentioned. Then, the cooperation processing module 121A receives a reply from another processing apparatus 100, which is transmitted in response to the request, through the communication device 130A (including the signal conversion gateway 140A as needed). Then, the cooperation processing module 121A selects another processing apparatus 100 from which the reply was transmitted. When there is the plurality of processing apparatuses 100, the cooperation processing module 121A selects the processing apparatus 100 according to the user's operation. Then, a communication with another processing apparatus 100 selected is performed.

Moreover, in the case of selecting the processing apparatus 100, it is possible to generate a list of the plurality of processing apparatuses 100 as connection candidates and to present it to the user.

In addition, information of the processing apparatus 100 returned in response to the search request may be stored as a connection candidate table 400 in the proximity information storage module 123A. In addition, the list may be generated from the connection candidate table 400. In addition, information of the selected processing apparatus 100, that is, information of the connected processing apparatus 100 may be stored as a connection information table 300 in the proximity information storage module 123A.

In addition, another processing apparatus 100 may be selected using a self-information table 500 stored in the self-information storage module 124A. That is, the self-information table 500 includes a column in which the policy in selecting a communication destination is stored. The cooperation processing module 121A may select another processing apparatus 100 on the basis of the policy stored in the self-information storage module 124A.

There are two cases of selecting another processing apparatus 100 as described above. In the first case, another processing apparatus 100 is selected using the self-information table 500. This is to present to the user a list of the processing apparatuses 100 and is needed in order to select the processing apparatus 100 to cooperate. In the second case, the processing apparatus 100 is selected according to the user's operation. In this case, the processing apparatus 100 is selected from the presented list of the processing apparatuses 100, and the selection may be performed two or more times.

The proximity information storage module 123A is accessed from the cooperation processing module 121A and stores the connection information table 300 and the connection candidate table 400.

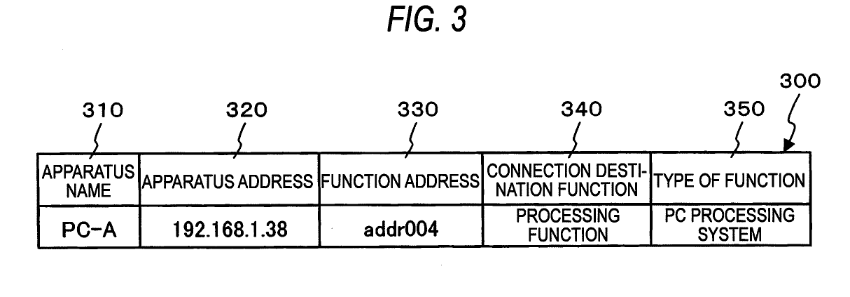

FIG. 3 is an explanatory view illustrating an example of the data structure of the connection information table 300. The connection information table 300 has an apparatus name column 310, an apparatus address column 320, a function address column 330, a connection destination function column 340, and a function type column 350 and stores information on the selected processing apparatus 100.

The apparatus name column 310 stores the apparatus name of the processing apparatus 100 at the connection destination. The apparatus name is used when being presented to the user, for example.

The apparatus address column 320 stores the address (for example, an IP address) which specifies the processing apparatus 100 at the connection destination.

The function address column 330 stores the address which specifies the function of the processing apparatus 100 at the connection destination.

The connection destination function column 340 stores the function that the processing apparatus 100 at the connection destination has. As the function, there are three kinds of functions including an input function, a processing function, and an output function.

The function type column 350 stores the type of function that the processing apparatus 100 at the connection destination has. The type of function stored in the function type column 350 is more specific than that stored in the connection destination function column 340. For example, there is the PC processing system (processing function using a processing device of a PC) in the case of the processing function, and there is a display, a printer, and the like in the case of the output function.

In addition, in the example shown in FIG. 3, one processing apparatus 100 is stored. However, when data can be input to the plurality of processing apparatuses 100, the plurality of processing apparatuses 100 are stored.

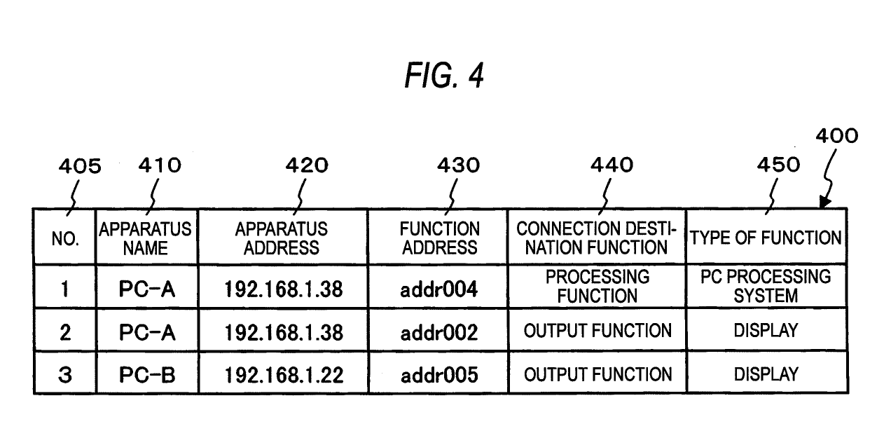

FIG. 4 is an explanatory view illustrating an example of the data structure of the connection candidate table 400. The connection candidate table 400 has a No column 405, an apparatus name column 410, an apparatus address column 420, a function address column 430, a connection destination function column 440, and a function type column 450 and stores information on the processing apparatus 100 returned in response to a search request of the cooperation processing module 121A. The connection candidate table 400 is the target of generation of the list presented to the user.

The No column 405 stores reference numerals indicating the order of the processing apparatus 100.

The apparatus name column 410 to the function type column 450 is equal to the apparatus name column 310 to the function type column 350 of the connection information table 300 shown in the example of FIG. 3.

The self-information storage module 124A is accessed from the cooperation processing module 121A and stores the self-information table 500.

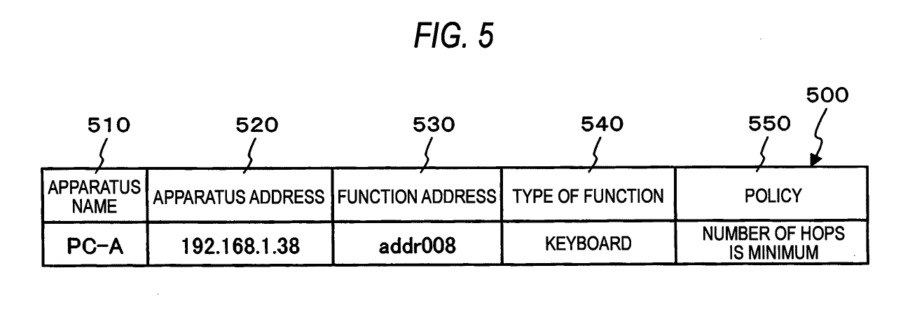

FIG. 5 is an explanatory view illustrating an example of the data structure of the self-information table 500. The self-information table 500 has an apparatus name column 510, an apparatus address column 520, a function address column 530, a function type column 540, and a policy column 550 and stores information on the processing apparatus 100 itself. The self-information table 500 is used when responding to a search request from another processing apparatus 100.

The apparatus name column 510 stores the apparatus name of the processing apparatus 100.

The apparatus address column 520 stores the address (for example, an IP address) which specifies the processing apparatus 100.

The function address column 530 stores the address which specifies the function of the processing apparatus 100.

The function type column 540 stores the type of the function that the processing apparatus 100 has. Here, since the processing apparatus 100 has the input function, the type of a function that the processing apparatus 100 has is a keyboard and the like.

The policy column 550 stores the policy in selecting the communication destination of the processing apparatus 100. The policy is for determining the processing apparatus 100 to which the processing apparatus 100 is to be connected. For example, the policy indicates the number of hops as a reference for selecting the nearest processing apparatus 100. Here, the number of hops refers to the number of routers through which the packet has passed until it reaches, for example, in order to communicate with the processing apparatus 100. In addition, examples of the policy include those physically connected by a wire (for example, a keyboard and a PC body), a communication type, and a type of display (priority is given to a rewritable one like the display) in addition to the number of hops. Alternatively, the user may define the policy. The processing apparatus 100 having an output function may be limited as the processing apparatus 100 to be selected.

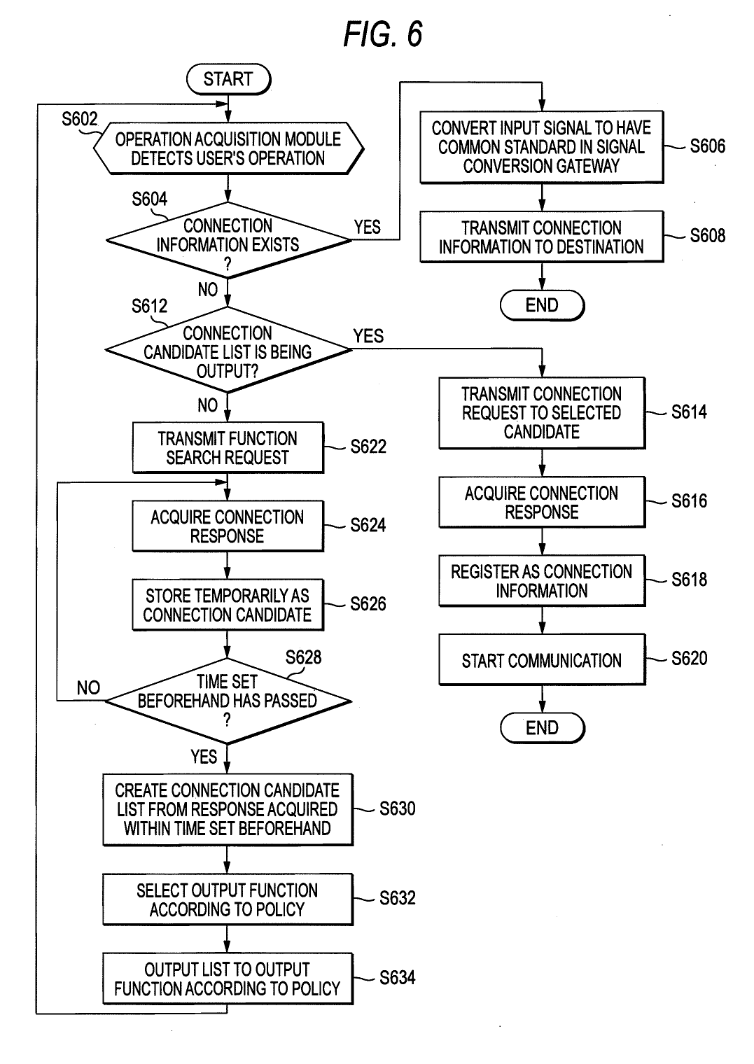

FIG. 6 is a flow chart illustrating an example of processing in the present exemplary embodiment for an input function.

In step S602, the operation acquisition module 122A detects a user's operation. The operations of the user can be separated into three types. The first one is the operation for the processing apparatus 100 for an input function and it starts the cooperation processing by the processing apparatus 100. In this case, ‘No’ is selected in step S604, ‘No’ is selected in step S612, and processing after step S622 is performed. The second one is an operation for selecting the processing apparatus 100 which is the connection destination. In this case, ‘No’ is selected in step S604, ‘Yes’ is selected in step S612, and processing of steps S614 to S620 is performed. The third one is the operation after already performing the cooperation. In this case, ‘Yes’ is selected in step S604 and processing of steps S606 and S608 is performed.

In step S604, the cooperation processing module 121A determines whether or not the connection information table 300 exists in the proximity information storage module 123A. When the connection information table 300 exists, the process proceeds to step S606. In other cases, the process proceeds to step S612.

In step S606, the cooperation processing module 121A makes the signal conversion gateway 140A convert the input signal into the communication signal based on the common standard.

In step S608, the cooperation processing module 121A transmits the communication signal converted in step S606 to the processing apparatus 100 at the destination, which is stored in the connection information table 300, through the communication device 130A.

In step S612, the cooperation processing module 121A determines whether or not the connection candidate table 400 within the proximity information storage module 123A is being output to the processing apparatus 100 for the output function as the selection list. When the connection candidate table 400 in the proximity information storage module 123A is being output, the process proceeds to step S614. In other cases, the process proceeds to step S622.

In step S614, the cooperation processing module 121A transmits the connection request to the processing apparatus 100 selected by the user through the communication device 130A.

In step S616, the cooperation processing module 121A acquires a connection response from the processing apparatus 100.

In step S618, the cooperation processing module 121A stores information on the processing apparatus 100, from which the connection response was acquired in step S616, in the connection information table 300 within the proximity information storage module 123A.

In step S620, the cooperation processing module 121A starts communication with the processing apparatus 100.

In step S622, the cooperation processing module 121A broadcasts the function search request through the communication device 130A.

In step S624, the cooperation processing module 121A acquires a search response which is the response to the search request from the processing apparatus 100.

In step S626, the cooperation processing module 121A temporarily stores information on the processing apparatus 100, from which the search response was acquired, in the connection candidate table 400 within the proximity information storage module 123A.

In step S628, the cooperation processing module 121A determines whether or not the time set beforehand has passed. An example of the time includes a time required until at least one search response is returned. When the time set beforehand has passed, the process proceeds to step S630. In other cases, the process proceeds to step S624.

In step S630, the cooperation processing module 121A creates a selection list from the search response (connection candidate table 400 within the proximity information storage module 123A) acquired in step S624.

In step S632, the cooperation processing module 121A selects the processing apparatus 100 for the output function in the list according to the policy stored in the policy column 550 of the self-information table 500 within the self-information storage module 124A.

In step S634, the cooperation processing module 121A outputs the list created in step S630 to the processing apparatus 100 selected in step S632.

FIG. 7 is a view illustrating the conceptual module configuration mainly in the configuration example of the cooperation control device 120 of the present exemplary embodiment for an output function. A functional device 110B, a cooperation control device 120B, a communication device 130B, and a signal conversion gateway 140B are included in the conceptual module configuration.

A functional device 110B is connected with the cooperation processing module 121B of a cooperation control device 120B and corresponds to the functional device 110 shown in the example of FIG. 1. For example, the functional device 110B receives data, which is to be output, from the cooperation processing module 121B and outputs it to a display, a printer, and the like.

The communication device 130B is connected with a cooperation processing module 121B of the cooperation control device 120B and corresponds to the communication device 130 shown in the example of FIG. 1. In order to perform communication with another processing apparatus 100, the communication device 130B transmits the signal from the cooperation processing module 121B to another processing apparatus 100 and receives a signal from another processing apparatus 100 and transmits it to the cooperation processing module 121B.

The signal conversion gateway 140B is connected to the cooperation processing module 121B of the cooperation control device 120B and corresponds to the signal conversion gateway 140 shown in the example of FIG. 1. The signal conversion gateway 140B converts a signal into a signal treated by the functional device 110B and the like in response to an instruction from the cooperation processing module 121B.

The cooperation control device 120B includes the cooperation processing module 121B, a proximity information storage module 123B, and a self-information storage module 124B and corresponds to the cooperation control device 120 shown in the example of FIG. 1.

The cooperation processing module 121B is connected with a proximity information storage module 123B, a self-information storage module 124B, the functional device 110B, a communication device 130B, and a signal conversion gateway 140B. The cooperation processing module 121B receives the request of a function transmitted from another processing apparatus 100 (for example, the processing apparatus 100 having an input function shown in FIG. 2). According to the request that is received, the cooperation processing module 121B transmits its own function to the processing apparatus 100. Then, the cooperation processing module 121B performs communication with the processing apparatus 100. Such transmission and reception is performed by the communication device 130B (also including the signal conversion gateway 140B as needed).

In addition, information on the processing apparatus 100 which has performed the request of a function may be stored as a connection information table 800 in the proximity information storage module 123B, or information on the processing apparatus 100 determined to be connected may be stored. In addition, using a self-information table 900 stored in the self-information storage module 124B, its own function may be transmitted to another processing apparatus 100.

The proximity information storage module 123B is accessed from the cooperation processing module 121B and stores the connection information table 800.

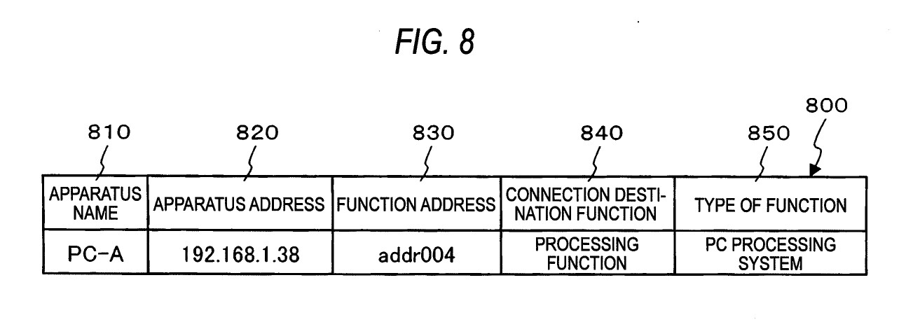

FIG. 8 is an explanatory view illustrating an example of the data structure of the connection information table 800. The connection information table 800 has an apparatus name column 810, an apparatus address column 820, a function address column 830, a connection destination function column 840, and a function type column 850. The connection information table 800 is the same as the connection information table 300 shown in the example of FIG. 3.

In addition, in the example shown in FIG. 8, one processing apparatus 100 is stored. However, when data can be output from the plurality of processing apparatuses 100, the plurality of processing apparatuses 100 are stored. Moreover, in the present exemplary embodiment, a connection with one processing apparatus 100 is assumed.

The self-information storage module 124B is accessed from the cooperation processing module 121B and stores the self-information table 900.

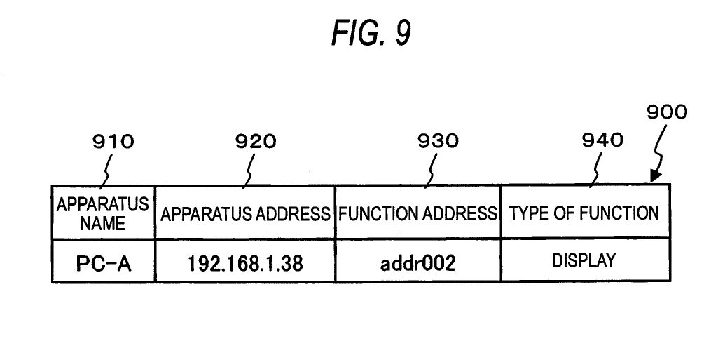

FIG. 9 is an explanatory view illustrating an example of the data structure of the self-information table 900. The self-information table 900 has an apparatus name column 910, an apparatus address column 920, a function address column 930, and a function type column 940. The connection information table 900 is the same as the self-information table 500 shown in the example of FIG. 5. Although the self-information table 900 is the same as the self-information table 500 shown in FIG. 5, the self-information table 900 does not have a policy column 550 since it is not necessary. This is because the processing apparatus 100 with an output function does not search the cooperation place from itself.

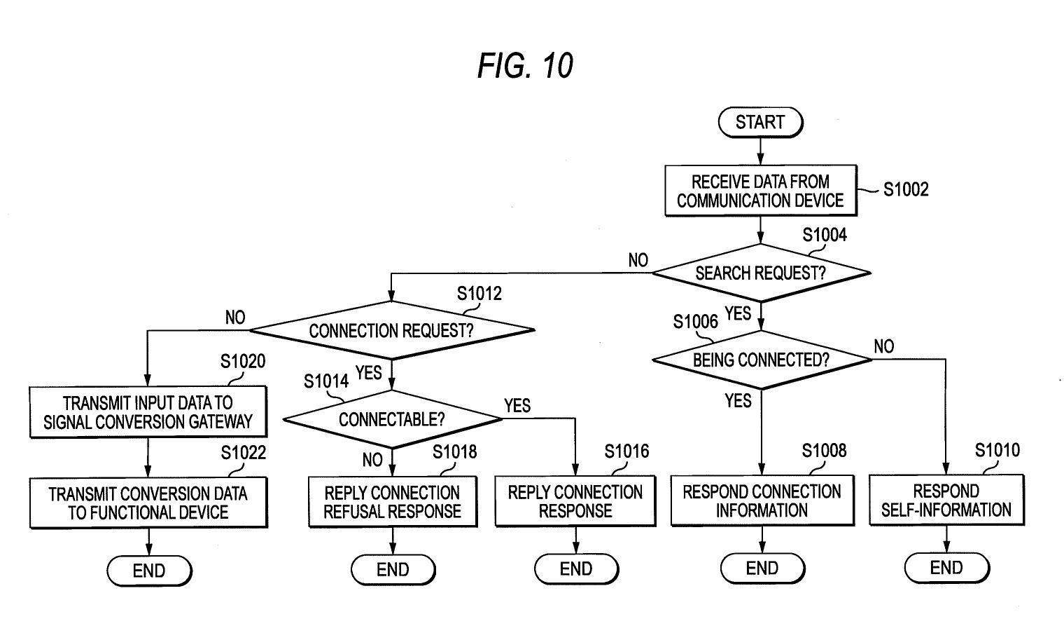

FIG. 10 is a flow chart illustrating an example of processing in the present exemplary embodiment for an output function.

In step S1002, the cooperation processing module 121B receives data, through the communication device 130B, from another processing apparatus 100 (for example, the processing apparatus 100 with an input function, the processing apparatus 100 having the processing function). There are three kinds of received data. The first one is a search request. In this case, ‘Yes’ is selected in step S1004 and processing of steps S1006 to S1010, which is processing for indicating that it can cooperate and the like, is performed. The second one is a connection request. In this case, ‘No’ is selected in step S1004, ‘Yes’ is selected in step S1012, and processing of steps S1014 to S1018 which is processing for connection with another processing apparatus 100 is performed. The third one is data of exchange with another processing apparatus 100 after already performing the cooperation. In this case, ‘No’ is selected in step S1004, ‘No’ is selected in step S1012, and processing of steps S1020 and S1022 is performed.

In step S1004, the cooperation processing module 121B determines whether or not the data received in step is a search request. When the data received in step is a search request, the process proceeds to step S1006. In other cases, the process proceeds to step S1012.

In step S1006, the cooperation processing module 121B determines whether or not it is already connected using the connection information table 800 within the proximity information storage module 123B. That is, the cooperation processing module 121B determines whether or not there is data in the connection information table 800. When it is already connected, the process proceeds to step S1008. In other cases, the process proceeds to step S1010.

In step S1008, the cooperation processing module 121B returns that it is already connected and information on its function as the connection information response.

In step S1010, the cooperation processing module 121B returns information on its function as a self-information response.

In step S1012, the cooperation processing module 121B determines whether or not the data received in step is a connection request. When the data received in step S1002 is a connection request, the process proceeds to step S1014. In other cases, the process proceeds to step S1020.

In step S1014, the cooperation processing module 121B determines whether or not connection with the processing apparatus 100 which has requested the connection is possible. When the connection is possible, the process proceeds to step S1016. In other cases, the process proceeds to step S1018.

In step S1016, the cooperation processing module 121B returns a response indicating that the connection is possible.

In step S1018, the cooperation processing module 121B returns a response indicating that the connection is refused.

In step S1020, the cooperation processing module 121B transmits the received data (data for output) to the signal conversion gateway 140B and receives converted data.

In step S1022, the cooperation processing module 121B transmits the data converted in step S1020 to the functional device 110B.

FIG. 11 is a view illustrating the conceptual module configuration mainly in a configuration example of the cooperation control device 120 of the present exemplary embodiment for a processing function. A functional device 110C, a cooperation control device 120C, a communication device 130C, and a signal conversion gateway 140C are included in the conceptual module configuration.

In the present exemplary embodiment for the processing function, the processing apparatus 100 having an input function and the processing apparatus 100 having an output function are combined.

The functional device 110C is connected to a cooperation processing module 121C and an operation acquisition module 122C of the cooperation control device 120C and corresponds to the functional device 110 shown in the example of FIG. 1. For example, the functional device 110C receives data from the cooperation processing module 121C and the operation acquisition module 122C and transmits the data to the cooperation processing module 121C after performing processing on the data.

The communication device 130C is connected with a cooperation processing module 121C of the cooperation control device 120C and corresponds to the communication device 130 shown in the example of FIG. 1. In order to perform communication with another processing apparatus 100, the communication device 130C transmits the signal from the cooperation processing module 121C to another processing apparatus 100 and receives a signal from another processing apparatus 100 and transmits it to the cooperation processing module 121C.

The signal conversion gateway 140C is connected to the cooperation processing module 121C of the cooperation control device 120C and corresponds to the signal conversion gateway 140 shown in the example of FIG. 1. The signal conversion gateway 140C converts a signal into a signal treated by the functional device 110C and the like in response to an instruction from the cooperation processing module 121C.

The cooperation control device 120C includes the cooperation processing module 121C, the operation acquisition module 122C, a proximity information storage module 123C, and a self-information storage module 124C and corresponds to the cooperation control device 120 as shown in the example of FIG. 1. Each module within the cooperation control device 120C is the same as that obtained by combining each module of the processing apparatus 100 having an input function with each module of the processing apparatus 100 having an output function.

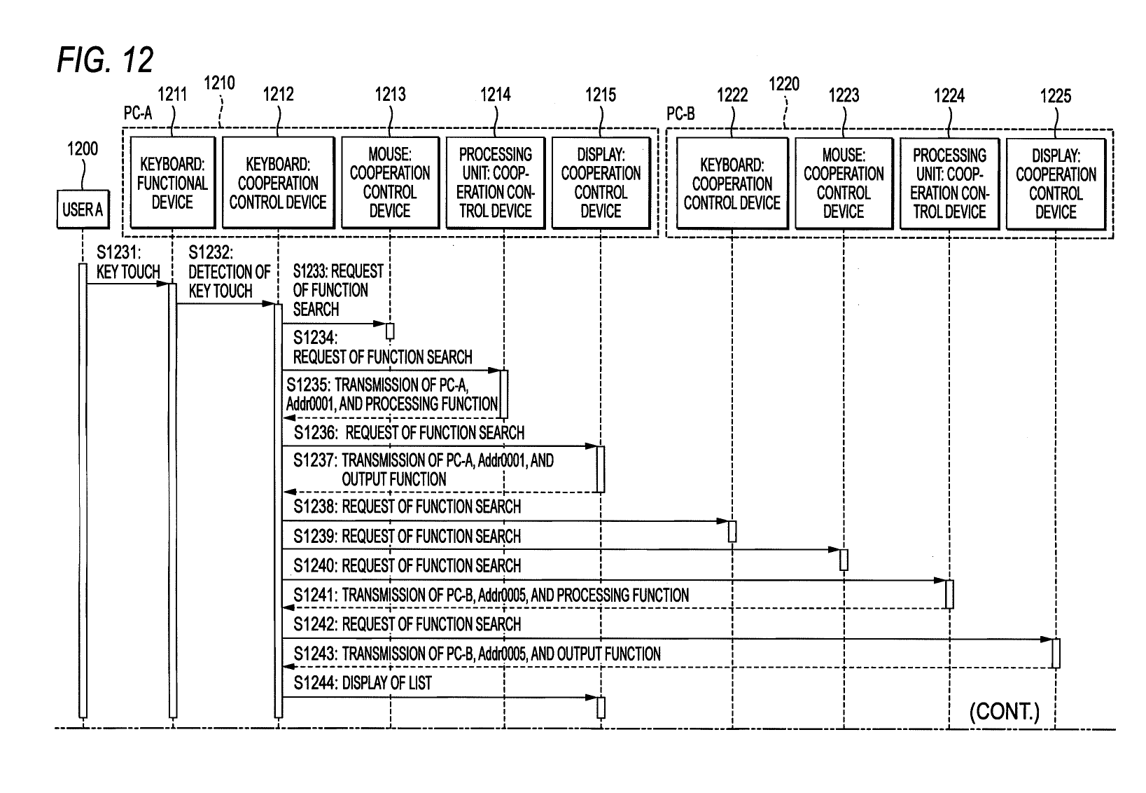

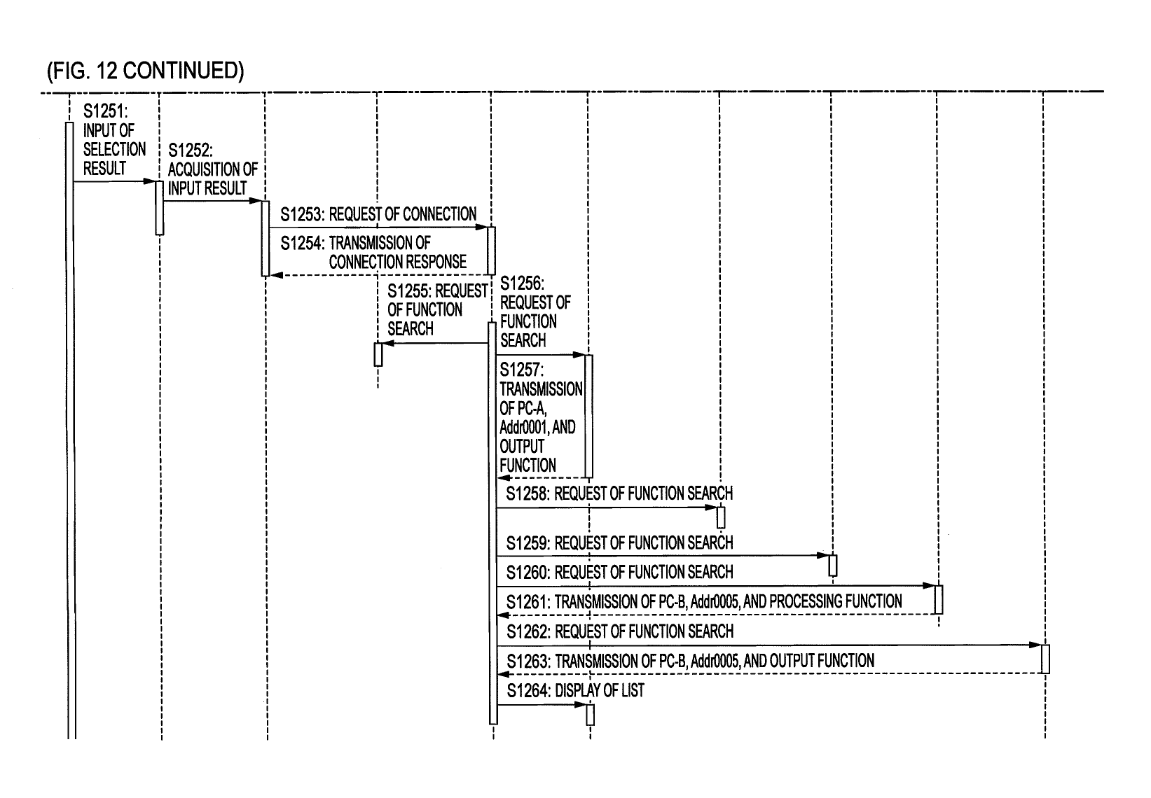

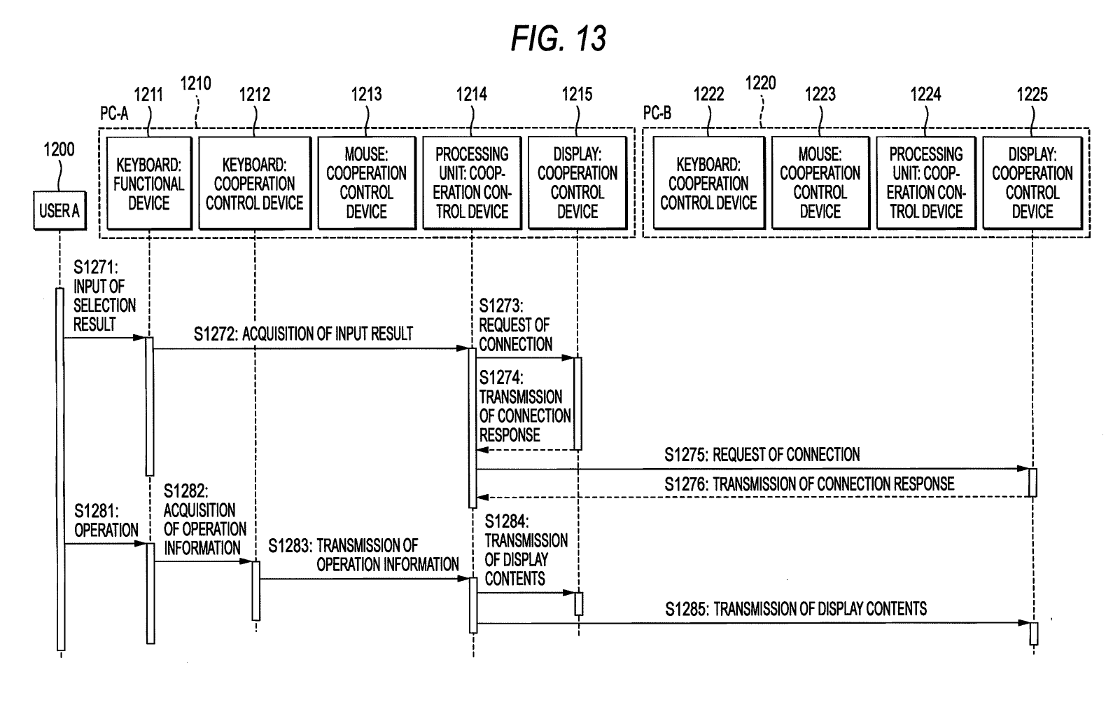

FIGS. 12 and 13 are timing charts illustrating examples of cooperation processing of a PC-A 1210 and a PC-B 1220. A user A 1200 processes data in the processing unit (cooperation control device 1214) of the PC-A 1210 using the keyboard (functional device 1211) of the PC-A 1210 and outputs the processing result to both the display (cooperation control device 1215) of the PC-A 1210 and the display (cooperation control device 1225) of the PC-B 1220. For example, the timing charts are used in a situation where two persons have PCs, respectively, and the operation processing result of one of the PCs is displayed on the displays of both the PCs.

In addition, the PC-A 1210 includes a keyboard (functional device 1211), a keyboard (cooperation control device 1212), a mouse (cooperation control device 1213), a processing unit (cooperation control device 1214), and a display (cooperation control device 1215). In addition, the PC-B 1220 includes a keyboard (cooperation control device 1222), a mouse (cooperation control device 1223), a processing unit (cooperation control device 1224), and a display (cooperation control device 1225). The keyboard (functional device 1211), the keyboard (cooperation control device 1212), the mouse (cooperation control device 1213), the keyboard (cooperation control device 1222), and the mouse (cooperation control device 1223) are modules within the processing apparatus 100 with an input function. The processing unit (cooperation control device 1214) and the processing unit (cooperation control device 1224) are modules within the processing apparatus 100 with the processing function. The display (cooperation control device 1215) and the display (cooperation control device 1225) are modules within the processing apparatus 100 having an output function.

The PC-A 1210 and the PC-B 1220 are communicably connected to each other by wire or wirelessly.

In step S1231, the user A 1200 touches a key of the keyboard of the PC-A 1210.

In step S1232, the keyboard (functional device 1211) detects the key touch and transmits it to the keyboard (cooperation control device 1212).

In step S1233 and the like, the keyboard (cooperation control device 1212) transmits a function search request. That is, the keyboard (cooperation control device 1212) transmits the search request to the many unspecified processing apparatuses 100 (here, the mouse (cooperation control device 1213), the processing unit (cooperation control device 1214), and the display (cooperation control device 1215), the keyboard (cooperation control device 1222), the mouse (cooperation control device 1223), the processing unit (cooperation control device 1224), and the display (cooperation control device 1225)).

In step S1235 and the like, the processing unit (cooperation control device 1214) and the like which have received the search request reply information on its processing apparatus 100, such as the apparatus name, the function address, and the connection destination function. In addition, there is no reply from the mouse (cooperation control device 1213), the keyboard (cooperation control device 1222), and the mouse (cooperation control device 1223) each of which is the processing apparatus 100 with the input function. This is because these do not cooperate with the keyboard (cooperation control device 1212).

In step S1244, the keyboard (cooperation control device 1212) creates a list of the processing apparatus 100 which sends a reply to the search request. Here, the processing unit (cooperation control device 1214), the display (cooperation control device 1215), the processing unit (cooperation control device 1224), and the display (cooperation control device 1225) are the contents of the list. In addition, the keyboard (cooperation control device 1212) transmits the list to the display (cooperation control device 1215), which corresponds to the policy, using the policy column 550 of the self-information table 500 and the display (cooperation control device 1215) displays the list.

In step S1251, the user A 1200 selects the processing apparatus 100 to cooperate with from the list displayed on the display (cooperation control device 1215) by using the keyboard of the PC-A 1210. Here, the processing unit (cooperation control device 1224) is selected.

In step S1252, the keyboard (functional device 1211) detects the selection and transmits it to the keyboard (cooperation control device 1212).

In step S1253, the keyboard (cooperation control device 1212) transmits a connection request to the selected processing unit (cooperation control device 1214).

In step S1254, the processing unit (cooperation control device 1214) returns the connection response indicating that the connection is possible.

In step S1255 and the like, the processing unit (cooperation control device 1214) transmits a function search request. That is, the processing unit (cooperation control device 1214) transmits the search request to the many unspecified processing apparatuses 100 (here, the mouse (cooperation control device 1213), the display (cooperation control device 1215), the keyboard (cooperation control device 1222), the mouse (cooperation control device 1223), the processing unit (cooperation control device 1224), and the display (cooperation control device 1225)). Here, the processing apparatus 100 with the processing function performs the same function as the processing apparatus 100 having an input function.

In step S1257 and the like, the display (cooperation control device 1215) and the like which have received the search request reply information on its processing apparatus 100, such as the apparatus name, the function address, and the connection destination function. In addition, there is no reply from the mouse (cooperation control device 1213), the keyboard (cooperation control device 1222), and the mouse (cooperation control device 1223) each of which is the processing apparatus 100 having an input function. This is because these do not cooperate with the processing unit (cooperation control device 1214).

In step S1264, the processing unit (cooperation control device 1214) creates a list of the processing apparatus 100 which sends a reply to the search request. Here, the display (cooperation control device 1215), the processing unit (cooperation control device 1224), and the display (cooperation control device 1225) are the contents of the list. In addition, the processing unit (cooperation control device 1214) transmits the list to the display (cooperation control device 1215), which corresponds to the policy, using the policy column 550 of the self-information table 500 and the display (cooperation control device 1215) displays the list.

In step S1271, the user A 1200 selects the processing apparatus 100 to cooperate with from the list displayed by the display (cooperation control device 1215) using the keyboard of the PC-A 1210. Here, the display (cooperation control device 1215) and the display (cooperation control device 1225) are selected.

In step S1272, the keyboard (functional device 1211) detects the selection and transmits it to the processing unit (cooperation control device 1214).

In step S1273, the processing unit (cooperation control device 1214) transmits a connection request to the selected display (cooperation control device 1215).

In step S1274, the display (cooperation control device 1215) returns a connection response indicating that the connection is possible.

In step S1275, the processing unit (cooperation control device 1214) transmits a connection request to the selected display (cooperation control device 1225).

In step S1276, the display (cooperation control device 1225) returns a connection response indicating that the connection is possible.

In step S1281, the user A 1200 performs an operation for processing in the processing unit (cooperation control device 1214) using the keyboard of the PC-A 1210.

In step S1282, the keyboard (functional device 1211) detects the operation and transmits the operation information to the keyboard (cooperation control device 1212).

In step S1283, the keyboard (cooperation control device 1212) transmits the operation information to the processing unit (cooperation control device 1214).

In step S1284, the processing unit (cooperation control device 1214) processes the operation information and transmits the result to the display (cooperation control device 1215). The display (cooperation control device 1215) displays it on the display.

In step S1285, the processing unit (cooperation control device 1214) transmits the same thing as that transmitted in step S1284 to the display (cooperation control device 1225). The display (cooperation control device 1225) displays it on the display.

Moreover, when connection with the processing apparatus 100 under cooperation is released (for example, when the processing apparatus 100 is separated from the communication line (for example, by turning off the power or physically unplugging the cable)), the cooperation control device 120 included in the processing apparatus 100 is disconnected.

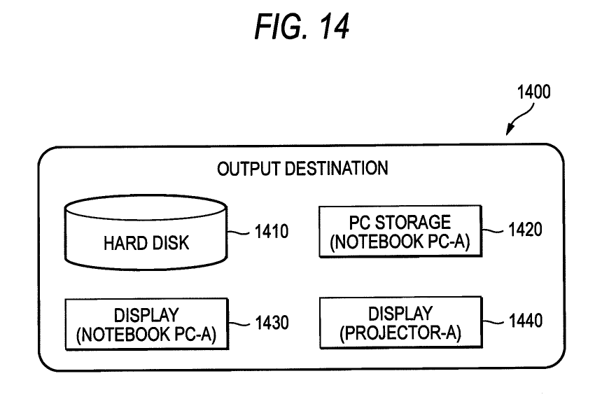

FIG. 14 is an explanatory view illustrating a display example in the case of selection processing in the present exemplary embodiment.

For example, it is the situation where a document is read and it is selected to which one of the processing apparatuses 100 in the neighborhood the image data is to be output in the case of mounting the present exemplary embodiment in the scanner (corresponding to step S1264 in the examples shown in FIGS. 12 and 13). In addition, the processing apparatus 100 with the function of document reading, the processing apparatus 100 having the function of displaying the read document on a display 1400, and the processing apparatus 100 having the function of storing the image data in the built-in hard disk are mounted in the scanner. Moreover, as peripheral devices which are communicable with the scanner, there is notebook PC-A and projector-A.

In addition, for example, when the operation of opening the cover of the scanner is detected, a hard disk (local saving) 1410 as the output destination of image data, PC storage (notebook PC-A) 1420, a display (notebook PC-A) 1430, and a display (projector-A) 1440 are displayed on the display 1400. The user selects one of them by a key operation or an operation on the touch panel, for example. Then, the image data read by the scanner is output to the selected one.

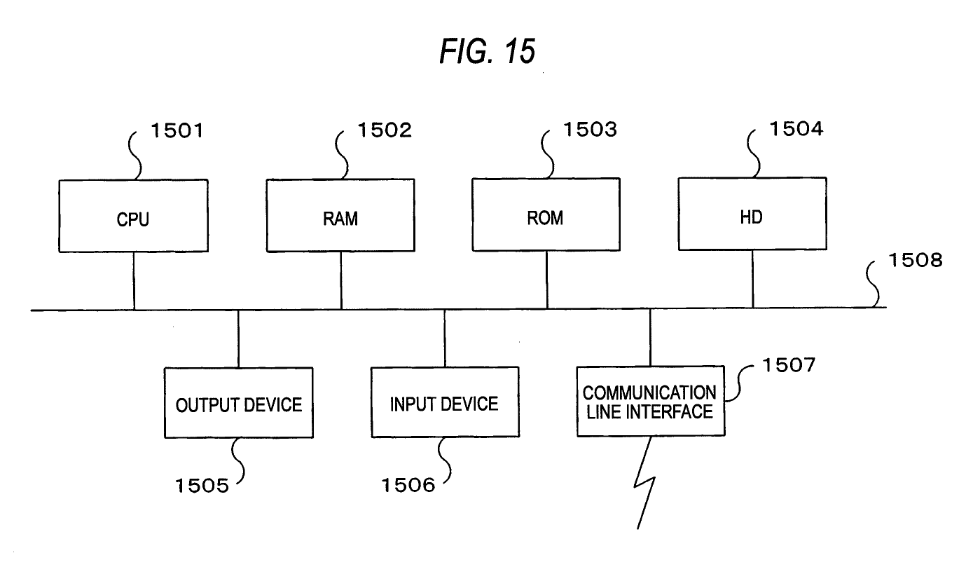

Furthermore, as illustrated in FIG. 15, the hardware configuration of the computer executed by the program as the present exemplary embodiment is the same as that of a typical computer. Specifically, the computer executed by the program as the present exemplary embodiment is a personal computer, the computer that can serve as a server, and the like. That is, as a specific example, a CPU 1501 is used as the processing unit (operation unit) and a RAM 1502, a ROM 1503, and a HD 1504 are used as storage devices. As the HD 1504, a hard disk may be used, for example. The computer is configured to include: the CPU 1501 which executes programs, such as the functional device 110 and the cooperation control device 120; the RAM 1502 which stores the programs or data; the ROM 1503 in which, for example, a program for starting the computer is stored; the HD 1504 which is the auxiliary storage device; an input device 1506, such as a keyboard or a mouse, used to input data; an output device 1505, such as a CRT or a liquid crystal display; a communication line interface 1507, such as a network interface card, for connection with a communication network; and a bus 1508 for performing data exchange by connecting those described above. The plurality of computers may be connected to each other through the network. Moreover, for example, in the case of configuring the computer shown in the example of FIG. 15 as the three processing apparatuses 100 having a processing function, the input function, and an output function, the processing apparatus 100 having the processing function is configured by the CPU 1501, the RAM 1502, the ROM 1503, the HD 1504, and the communication line interface 1507, the processing apparatus 100 having an input function is configured by the input device 1506, the CPU 1501, the RAM 1502, the ROM 1503, the HD 1504, and the communication line interface 1507, and the processing apparatus 100 having an output function is configured by the output unit 1505, the CPU 1501, the RAM 1502, the ROM 1503, the HD 1504, and the communication line interface 1507.

In the case of the exemplary embodiment based on the computer program, the exemplary embodiment is realized by reading the computer program, which is software, into the system with the above-described hardware configuration and making the software and hardware resources cooperate with each other.

In addition, the hardware configuration shown in FIG. 15 is an example of the configuration. The present exemplary embodiment is not limited to the configuration shown in FIG. 15 but may be configured in which the modules described in the present exemplary embodiment can be executed. For example, some of the modules may be configured using dedicated hardware (for example, ASIC), or some of the modules may be provided in an external system so as to be connected to each other through a communication line. In addition, a plurality of systems shown in FIG. 15 may be connected to each other through a communication line so as to operate cooperatively. In particular, in addition to the personal computer, the modules may be included in information appliances, a copying machine, a facsimile, a scanner, a printer, a complex machine (image processing apparatus having two or more functions of a scanner, a printer, a copying machine, and a facsimile), and the like.

The above-mentioned program may be stored in a recording medium and then provided, or the program may be provided through a communication unit. In this case, for example, the above-mentioned program may be implemented as a “computer-readable recording medium having a program recorded thereon”.

The “computer-readable recording medium having a program recorded thereon” means a computer-readable recording medium on which a program is recorded and which is used to install, execute, and distribute a program.

Examples of the recording medium include digital versatile disks (DVDs), such as “DVD-R, DVD-RW, and DVD-RAM” of which the standard is defined by the DVD forum and “DVD+R and DVD+RW” of which the standard is defined as DVD+RW, compact disks (CDs), such as a read only memory (CD-ROM), a CD recordable (CD-R), and a CD rewritable (CD-RW), a blue-ray disc (registered trademark), a magneto-optical disk (MO), a flexible disk (FD), a magnetic tape, a hard disk, a read only memory (ROM), an electrically erasable and programmable read only memory (EEPROM), a flash memory, and a random access memory (RAM).

The above-mentioned program or a part thereof may be recorded on the recording medium and then the recording medium may be held or distributed. The program or a part thereof may be transmitted by communication using a transmission medium, such as a wired communication network, a wireless communication network, or a combination thereof. Examples of the wired communication network include a local area network (LAN), a metropolitan area network (MAN), a wide area network (WAN), the Internet, the Intranet, and the Extranet. In addition, the program or a part thereof may be transmitted on a carrier wave.

The program may be a part of another program, or it may be recorded on a recording medium along with another program. The program may be separately recorded on a plurality of recording media. The program may be recorded by any method, such as compression or encryption, as long as it can be restored.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A processing system comprising:
a first processing apparatus; and
second processing apparatuses,
wherein the first processing apparatus includes:
an operation detection unit that detects an operation;
a request unit that requests the second processing apparatuses to transmit functions when the operation is detected by the operation detection unit;
a receiving unit that receives replies in response to the requests of the request unit from at least one of the second processing apparatuses;
a selection unit that selects at least one of the second processing apparatuses from which the receiving unit has received the replies; and
a communication unit that performs communication with the at least one of the second processing apparatuses selected by the selection unit, and
each of the second processing apparatuses includes:
a receiving unit that receives the request of the function transmitted from the first processing apparatus;
a transmission unit that transmits its own function to the first processing apparatus in response to the request received by the receiving unit; and
a communication unit that performs communication with the first processing apparatus.

2. A processing apparatus comprising:
an operation detection unit that detects an operation;
a request unit that requests other processing apparatuses to transmit functions when the operation is detected by the operation detection unit;
a receiving unit that receives replies in response to the requests of the request unit from the at least one of the other processing apparatuses;
a selection unit that selects at least one of the other processing apparatuses from which the receiving unit has received the replies; and
a communication unit that performs communication with the at least one of the other processing apparatuses selected by the selection unit.

3. A processing apparatus comprising:
a receiving unit that receives the request of the function transmitted from the processing apparatus according to claim 2;
a transmission unit that transmits its own function to the processing apparatus in response to the request received by the receiving unit; and
a communication unit that performs communication with the processing apparatus.

4. The processing apparatus according to claim 2, further comprising:
a signal conversion unit that converts a communication signal in order to perform communication with the other processing apparatuses; and
a function processing unit that performs processing for realizing its own function.

5. The processing apparatus according to claim 4,
wherein the function processing unit realizes any one function of reception, output, and processing of information.

6. The processing apparatus according to claim 2, further comprising:
a storage unit that stores a policy for selecting a communication destination,
wherein the selection unit selects the at least one of the other processing apparatuses based on the policy stored in the storage unit.

7. A computer readable medium storing a program causing a computer to execute a process for cooperating processing apparatuses, the process comprising:
detecting an operation;
requesting other processing apparatuses to transmit functions when the operation is detected;
receiving replies in response to the requests from the at least one of the other processing apparatuses;
selecting at least one of the other processing apparatuses which has transmitted the replies; and
performing communication with the selected at least one of the other processing apparatuses.
